(19) United States
(12) Patent Application Publication
(10) Pub. No.: US 2023/0064299 A1
(43) Pub. Date: Mar. 2, 2023

(54) Disc for Disc Golf

(71) Applicant: Latitude 64 AB, Skellefteå (SE)

(72) Inventor: Tomas Ekström, Skellefteå (SE)

(21) Appl. No.: 17/724,164

(22) Filed: Apr. 19, 2022

(30) Foreign Application Priority Data
Sep. 2, 2021 (SE) 2151094-6

(51) Int. Cl. A63B 65/10; A63B 67/06; C09D 175/04

(52) U.S. Cl. CPC A63B 65/10; A63B 67/06; C09D 175/04; A63B 2209/00

(57) ABSTRACT

A disc for disc golf, the disc including a central plate portion and a rim surrounding said central plate portion and extending from the plate portion in an axial direction of the disc. The central plate portion includes a core of a first polymer-based material, and, at least in the region of the rim, there is provided a second polymer-based material, which is chemically bonded to the first polymer-based material and which forms an outer surface of the disc. The first polymer-based material has a higher tensile strength than the second polymer-based material, and the second polymer-based material is softer than the first polymer-based material. The first polymer-based material forms a core of the rim and the second polymer-based material forms a coating on top of the first polymer-based material and encloses the core of the rim.

### CROSS-REFERENCE TO RELATED APPLICATION

The present application claims priority to Swedish Application No. 2151094-6, filed on Sep. 2, 2021. The entire contents of this application is incorporated herein by reference in its entirety.

### TECHNICAL FIELD

The present invention relates to a disc for disc golf, comprising a central plate portion and a rim surrounding said central plate portion and extending from the plate portion in an axial direction of the disc, wherein at least said central plate portion comprises a core of a first polymer-based material, and wherein at least in the region of the rim, there is provided a second polymer-based material, which is chemically bonded to the first polymer-based material and which forms an outer surface of the disc.

### BACKGROUND OF THE INVENTION

Discs for disc golf are well known. They comprise a central plate portion and a rim that surrounds the central plate portion and extends in an axial direction from the central plate portion.

In disc golf it is of importance to the thrower that he or she gets a good grip of the disc and that he or she does not need to apply excessive force to hold the disc. It is also important that the disc has such rigidity that it does not bend out and/or wobbles, and such that it can withstand the forces applied thereon in connection to landing and hitting objects such as the structure of the goal basket without being permanently deformed and getting deteriorated flying properties. Materials that to a certain level combine these requested properties are used in contemporary discs. However, improvement can yet be achieved.

It is an object of the present invention to present a disc design that will result in a disc with great mechanical strength and that still enables the thrower to get a good grip thereof, also under conditions that may be challenging when it comes to grip preconditions. The disc should also have properties that makes it easy to catch by a receiving person when thrown from one person to another.

It is also an object of the invention to present a disc for disc golf that will not bounce away from structures of a goal basket when hitting the latter, but that will instead tend to fall into the basket.

### SUMMARY

The object of the invention is achieved by means of a disc for disc golf, the disc comprising a central plate portion and a rim surrounding said central plate portion and extending from the plate portion in an axial direction of the disc, wherein said central plate portion comprises a core of a first polymer-based material, and at least in the region of the rim, there is provided a second polymer-based material, which is chemically bonded to the first polymer-based material and which forms an outer surface of the disc, wherein the first polymer-based material has a higher tensile strength than the second polymer-based material, and that the second polymer-based material is softer than the first polymer-based material, and wherein the first material forms a core of the rim and the second material forms a coating on top of the first material and encloses the core of the rim.

The first material may thus be optimized with regard to mechanical properties that will promote a stable flight of the disc and that will prevent the disc from being permanently deformed when hitting the ground or other objects. The second material will be optimized with regard to grip performance and friction. Chemical bonding is a bonding in which the first and second materials are directly interconnected with each other, and not via, for example, an adhesive or the like. The bonding may preferably be the result of a thermal process in which the first and second materials are in a liquid state and are allowed to bond as they solidify. According to one embodiment, the chemical bonding between the first material and the second materials is the result of an injection moulding process in which the two materials are injected almost simultaneously in a mould and permitted to solidify together in said mould.

According to one embodiment, the thickness of the coating of the second polymer-based material that encloses the core of the rim is 1.0-7.0 mm. Discs with such thickness of the coating enclosing the rim are more suitable as putter discs, aimed for putting into the goal basket from shorter distance.

According to another embodiment, the thickness of the coating of the second polymer-based material that encloses the core of the rim is 0.005-1.0 mm, preferably 0.005-0.01 mm. Such design is particularly suitable for driver discs aimed for long-throwing, which discs are less likely to be used in the nearness of the goal basket. However, also for these discs, there is an advantage to have the softer coating around the rim, since also these discs may sometimes reach the goal basket.

According to one embodiment, the first material has a tensile strength which is at least 5 MPa higher than the tensile strength of the second material.

According to one embodiment, the first material has a tensile strength which is at least 10 MPa higher than the tensile strength of the second material.

According to one embodiment, the core in the central plate portion has a thickness of at least 0.3 mm.

According to one embodiment, the first material has a tensile strength above 15 MPa. According to one embodiment, the first material has a tensile strength above 45 MPa. Measurement of tensile strength may preferably be according to standard ASTM D412, although other suitable standards may alternatively be used.

According to one embodiment, the second material has a hardness which is below 50 Shore D, preferably below 45 Shore D, or even below 40 Shore D. Measurement of the hardness is preferably made according to ASTM D2240, although other suitable standards may alternatively be used.

According to one embodiment, the first material has a hardness which is above 30 Shore D, preferably above 45 Shore D. According to one embodiment, the second material has a hardness which is at least 2 Shore D units lower than the hardness of the first material. According to one embodiment, the second material has a hardness which is at least 5 Shore D units lower than the hardness of the first material. Measurement of the hardness is preferably made according to ASTM D2240, although other suitable standards may alternatively be used.

According to one embodiment, the central plate portion is generally circular and has a radius r, and wherein, at least on the side of central plate portion from which the rim extends in said axial direction, a coating of the second material covers the core of the central plate portion from the rim and at least 0.25 r towards a centre of the disc.

According to one embodiment, the central plate portion is generally circular and has a radius r, and wherein, at least on the side of central plate portion from which the rim extends in said axial direction, a coating of the second material covers the core of the central plate portion from the rim and at least 0.75 r towards a centre of the disc.

According to one embodiment, the central plate portion is generally circular and has a radius r, and wherein, on a side of the central plate portion which is opposite to the side of the central plate portion from which the rim extends in said axial direction, a coating of the second material covers the core of the central plate portion from the rim and at least 0.25 r towards a centre of the disc.

According to one embodiment, the central plate portion is generally circular and has a radius r, and wherein, on a side of the central plate portion which is opposite to the side of the central plate portion from which the rim extends in said axial direction, a coating of the second material covers the core of the central plate portion from the rim and at least 0.75 r towards a centre of the disc.

According to one embodiment, the second material forms a coating which covers and encloses at least 95% of the outer surface area of a core formed by the first material.

According to one embodiment, the first material comprises any of a thermoplastic urethane, TPU, or a thermoplastic elastomer material TPE.

According to one embodiment, the second material comprises any of a thermoplastic urethane, TPU, or a thermoplastic elastomer material, TPE.

The first and the second polymer material may be of the same chemical composition, such as TPU, provided that they have the differences in tensile strength and hardness taught by the present invention.

According to one embodiment, the thermoplastic elastomer material TPE comprises any one from the group consisting of thermoplastic olefins (TPE-O), thermoplastic block copolymers (TPE-S), thermoplastic vulcanized polypropylene-EPDM-mixtures (TPE-V), thermoplastic polyester mixtures (TPE-E), including Copolyester (TPC-ET), thermoplastic urethanes (TPE-U), thermoplastic polyamides (TPE-A).

According to one embodiment, the disc has a diameter in the range of 20-23 cm, the central plate portion has a thickness in the range of 1.5-3.0 mm, preferably with increasing thickness towards the rim, and the rim has a maximum thickness of 0.5-3.0 cm in the radial direction of the disc and a height in the axial direction of the disc in the range of 1.0-3.0 cm.

According to one embodiment, the second polymer-based material is provided as a coating on the first polymer-based material and has a thickness in the range of 0.05-1.0 mm in the region of the central plate portion. In the region of the rim, where the second polymer-based material encloses the core of the rim, the thickness of the coating is either 1.0-7.0 mm (typically for putter discs) or 0.005-1.0 mm, preferably 0.005-0.01 mm (typically for driver discs)

According to one embodiment, the coating (4) has a thickness in the range of 0.05-1.0 mm in the region of a central part of the central plate portion 1, decreasing to a thickness of 0.01 mm in a region adjacent to the rim, and a thickness in the range of 0.005-0.01 mm in the region where it encloses the core of the rim.

According to one embodiment, the first polymer material forms a continuous core extending through the central plate portion and in the rim, wherein, in said rim, the core has a maximum thickness of 2.0-6.0 mm in the radial direction of the disc.

### BRIEF DESCRIPTION OF THE DRAWINGS

An embodiment of a disc according to the present invention will be presented more in detail with reference to the enclosed drawing, on which

FIG. 1 is cross-section of a disc according to an embodiment of the invention.

### DETAILED DESCRIPTION OF THE DRAWINGS

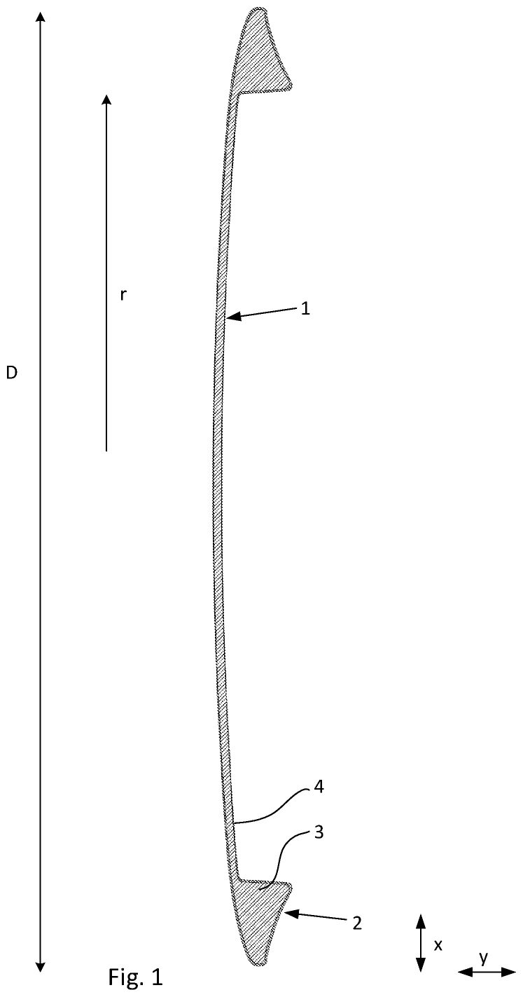

FIG. 1 shows a schematic representation of a cross-section of a disc for disc golf according to the present invention. The disc comprises a central plate portion 1 and a rim 2 surrounding the central plate portion 1. The central plate portion 1 has a certain curvature but extends mainly in a plane which is parallel with a radius of the central plate portion 1, defining a radial direction x. The central plate portion 1 is circular. The rim 2 extends from the central plate portion 2 in an axial direction y of the disc, perpendicular to the radial direction x.

The central plate portion 1 as well as the rim comprises a continuous core 3 of a first polymer-based material, and a coating 4 of a second polymer-based material, which is chemically bonded to the first polymer-based material and which forms an outer surface of the disc. In the embodiment presented here, the first polymer-based material consists of thermoplastic urethane, TPU, having a hardness of 50 Shore D and a tensile strength of 50 MPa. The second polymer consists of a thermoplastic block copolymer (TPE-S) having a hardness of 40 Shore D and a tensile strength of 40 MPa. Measurement of tensile strength is made according to standard ASTM D412, while measurement of the hardness is made according to ASTM D2240.

The chemical bonding between the first polymer material and the second polymer material is the result of an injection moulding process in which the two materials are injected almost simultaneously in a mould and permitted to solidify together in said mould.

The coating 4 which covers and encloses at least 95% of the outer surface area of the core 3 formed by the first material. Only in the region of where the polymers have been injected into the mould is there a very small area where there is no coverage. This area may be almost negligible compared to the total outer surface of the disc.

According to one embodiment, the disc has a diameter of 211 mm, the central plate portion has a thickness of 2.0 mm in a central region thereof, increasing up to 3 mm in adjacent to the rim (as a result of the coating 4 growing thicker towards the rim 2). The core 3 in the central plate portion 1 has a thickness of 1.8 mm. The rim has a maximum thickness of 10.0 mm in the radial direction x of the disc and a height of approximately 20 mm the axial direction y of the disc.

According to one embodiment, the coating 4 has a thickness in the range of 0.1 mm in the region of a central part of the central plate portion 1, increasing to a thickness of 1.0 mm in a region adjacent to the rim, and a thickness in the range of 1.0-4.1 mm in the region of the rim 2 (thinner towards the central plate portion 1 and on an inside of the disc). In the rim 2, the core 3 has a maximum thickness in the radial direction x of 5.5 mm.

According to an alternative embodiment, the coating 4 has a thickness in the range of 0.1 mm in the region of a central part of the central plate portion 1, decreasing to a thickness of 0.01 mm in a region adjacent to the rim, and a thickness in the range of 0.01 mm in the region where it encloses the core 3 of the rim 2.

1. A disc for disc golf, comprising
a central plate portion and a rim surrounding the central plate portion (1) and extending from the plate portion (1) in an axial direction of the disc,
wherein:
the central plate portion comprises a core (3) of a first polymer-based material,
at least in the region of the rim, there is provided a second polymer-based material, which is chemically bonded to the first polymer-based material and which forms an outer surface of the disc,
the first polymer-based material has a higher tensile strength than the second polymer-based material,
the second polymer-based material is softer than the first polymer-based material, and
the first polymer-based material forms a core of the rim and the second polymer-based material forms a coating on top of the first polymer-based material and encloses the core of the rim.

2. The disc according to claim 1, wherein a thickness of the coating of the second polymer-based material that encloses the core of the rim is 1.0-7.0 mm.

3. The disc according to claim 1, wherein the thickness of the coating of the second polymer-based material that encloses the core of the rim is 0.005-1.0 mm.

4. A disc according to claim 1, wherein the first material has a tensile strength which is at least 5 MPa higher than a tensile strength of the second material.

5. The disc according to claim 4, wherein the tensile strength of the first material is at least 10 MPa higher than the tensile strength of the second material,

6. The disc according to claim 4, wherein the tensile strength of the first material is above 15 MPa.

7. The disc according to claim 1, wherein the second material has a hardness which is below 50 Shore D.

8. The disc according to claim 1, wherein the first material has a hardness which is above 30 Shore D.

9. The disc according to claim 1, wherein the central plate portion is generally circular and has a radius r, and wherein, at least on the side of central plate portion from which the rim extends in the axial direction, a coating of the second material covers the core of the central plate portion from the rim and at least 0.25 r towards a center of the disc.

10. The disc according to claim 9, wherein, at least on the side of central plate portion from which the rim extends in the axial direction, the coating of the second material covers the core of the central plate portion from the rim and at least 0.75 r towards the center of the disc.

11. The disc according to claim 1, wherein the central plate portion is generally circular and has a radius r, and wherein, on a side of the central plate portion which is opposite to the side of the central plate portion from which the rim extends in the axial direction, a coating of the second material covers the core of the central plate portion from the rim and at least 0.25 r towards a center of the disc.

12. The disc according to claim 11, wherein, on a side of the central plate portion which is opposite to the side of the central plate portion from which the rim extends in the axial direction, the coating of the second material covers the core of the central plate portion from the rim and at least 0.75 r towards the center of the disc.

13. The disc according to claim 1, wherein the second material forms a coating which covers and encloses at least 95% of the outer surface area of a core formed by the first material.

14. The disc according to claim 1, wherein the first material comprises any of a thermoplastic urethane or a thermoplastic elastomer material.

15. The disc according to 1, wherein the second material comprises any of a thermoplastic urethane or a thermoplastic elastomer material.

16. The disc according to claim 14, wherein the thermoplastic elastomer material comprises any one from the group consisting of thermoplastic olefins, thermoplastic block copolymers, thermoplastic vulcanized polypropylene-EPDM-mixtures, thermoplastic polyester mixtures, Copolyester, thermoplastic urethanes thermoplastic polyamides.

17. The disc according to claim 1, wherein the disc has a diameter in the range of 20-23 cm, the central plate portion has a thickness in the range of 1.5-3.0 mm, the rim has a maximum thickness of 0.5-3.0 cm in the radial direction of the disc and a height in the axial direction of the disc in the range of 1.0-3.0 cm.

18. The disc according to claim 17, wherein the second polymer-based material is provided as a coating on the first polymer-based material and has a thickness in the range of 0.05-1.0 mm in the region of the central plate portion and a thickness of 1.0-7.0 mm in the region of the rim.

19. The disc according to claim 1, wherein the coating has a thickness in the range of 0.05-1.0 mm in the region of a central part of the central plate portion, a thickness of 0.01 mm in a region adjacent to the rim, and a thickness in the range of 0.005-0.01 mm in the region where the coating encloses the core of the rim.

20. The disc according to claim 15, wherein the thermoplastic elastomer material comprises any one from the group consisting of thermoplastic olefins thermoplastic block copolymers, thermoplastic vulcanized polypropylene-EPDM-mixtures, thermoplastic polyester mixtures, Copolyester, thermoplastic urethanes thermoplastic polyamides.
